(19) United States
(12) Patent Application Publication
(10) Pub. No.: US 2025/0116983 A1
(43) Pub. Date: Apr. 10, 2025

(54) INDUSTRIAL CONTROLLER DEVICE WITH USER CONFIGURATION CAPABILITIES

(71) Applicant: UI LABS, d/b/a MXD USA, Chicago, IL (US)

(72) Inventor: Eric Joseph Kozikowski, Roselle, IL (US)

(21) Appl. No.: 18/907,089

(22) Filed: Oct. 4, 2024

Related U.S. Application Data
(60) Provisional application No. 63/588,449, filed on Oct. 6, 2023.

(51) Int. Cl. G05B 19/042

(52) U.S. Cl. CPC G05B 19/0425; G05B 2219/1105; G05B 2219/13144

(57) ABSTRACT

An industrial controller device includes input ports configured to couple with sensors and output ports configured to couple with industrial output devices. The industrial controller device also includes a display device configured to display a graphical user interface to a user. The industrial controller device additionally includes a processor configured to obtain sensor information regarding a sensor coupled with an input port of the industrial controller device. The sensor information may be provided by the user via the graphical user interface. The sensor may be configured to measure a parameter of an industrial output device. The processor is also configured to acquire sensor signals from the sensor via the input port, to generate sensor measurement data based on the sensor information and the sensor signals, and to perform at least one action with respect to the sensor measurement data.

### Cross References to Related Applications

This application claims the benefit of and priority to U.S. Provisional Patent App. No. 63/588,449, entitled “Industrial Control System,” filed on Oct. 6, 2023, the disclosure of which is hereby expressly incorporated herein by reference in its entirety.

### FIELD OF TECHNOLOGY

The present disclosure relates generally to an industrial controller device.

### BACKGROUND

Industrial control systems in which an industrial controller may be used to monitor and control industrial equipment are typically custom-designed for the particular applications in which the industrial control systems are used. Control inputs (e.g., sensors, buttons, switches, etc.) are preplanned and are wired into an industrial controller. The industrial controller is then preprogrammed using code, such as Python, C, or Ladder Logic, to recognize and process the control inputs. Control outputs (e.g., lights, motor control signals, other action items, etc.) are also wired into the industrial controller and programmed using code to be correlated with the control inputs. Thus, conventional industrial control systems typically require a software or systems engineer skilled in a programming language, such Python, C, or Ladder Logic, to write code for monitoring and/or controlling industrial equipment. Further, with such typical industrial control systems, changes to the control system are difficult and require special skills. For example, in order to switch an input sensor to a different sensor, the system needs to be rewired and the code needs to be changed for the industrial control system to operate with the new sensor. Such changes may require special personnel that may not be available at a manufacturing plant, such as at a relatively small manufacturing plant. Thus, many small manufacturing plants do not employ industrial control functionalities to monitor and/or control industrial processes performed at the manufacturing plant. As a result, the industrial processes may be performed sub-optimally. Further, malfunctions of industrial equipment used at the manufacturing plant may go undetected, which may lead to damage to the industrial equipment. Such damaged equipment then needs to be repaired or replaced, which may be expensive in terms of both costs associated with fixing or replacing the industrial equipment and costs associated with downtime of the industrial equipment.

### SUMMARY

According to an embodiment, an industrial controller device is provided. The industrial controller device includes one or more input ports configured to couple with one or more sensors and one or more output ports configured to couple with one or more industrial output devices. The industrial controller device also includes a display device configured to display a graphical user interface to a user. The industrial controller device additionally includes a processor coupled to the one or more input ports, the one or more output ports, and the display device. The processor is configured to obtain sensor information regarding a sensor coupled with an input port among the one or more input ports. The sensor information may be provided by the user via the graphical user interface. The sensor may be configured to measure a parameter of an industrial output device. The processor is also configured to acquire sensor signals from the sensor via the input port. The processor is additionally configured to generate sensor measurement data based on i) the sensor information provided by the user via the graphical user interface and ii) the sensor signals acquired from the sensor via the input port. The processor is further configured to perform one or more of i) providing the sensor measurement data to the user, ii) saving the sensor measurement data for future use, or iii) controlling the industrial output device via an output port among the one or more output ports of the industrial controller device.

According to another embodiment, an industrial controller device is provided. The industrial controller device includes a housing, one or more input ports packaged within the housing, the one or more input ports configured to couple with one or more sensors coupled with one or more industrial output devices, and a display device packaged within the housing, the display device configured to display a graphical user interface to a user. The industrial controller device may also include a processor packaged within the housing and coupled to the one or more input ports and the display device. The processor is configured to obtain sensor information regarding a sensor coupled with an input port among the one or more input ports. The sensor information may be provided by the user via the graphical user interface. The sensor may be configured to measure a parameter of an industrial output device. The processor is also configured to acquire sensor signals from the sensor via the input port. The processor is further configured to generate sensor measurement data based on i) the sensor information provided by the user via the graphical user interface and ii) the sensor signals acquired from the sensor via the input port. The processor is additionally configured to provide the sensor measurement data to the user.

According to still another embodiment, a method for operating an industrial controller device is provided. The method includes obtaining, by a processor of the industrial controller device, sensor information regarding a sensor coupled with an input port of the industrial controller device. The sensor information may be provided by a user via a graphical user interface displayed to the user on a display device integrated into the industrial controller device. The sensor may be configured to measure a parameter of an industrial output device. The method also includes acquiring, by the processor via the input port, sensor signals from the sensor coupled with the input port. The method additionally includes generating, by the processor, sensor measurement data based on i) the sensor information provided by the user via the graphical user interface and ii) the sensor signals acquired from the sensor via the input port. The method further includes performing, by the processor, one or more of i) providing the sensor measurement data to the user, ii) saving the sensor measurement data for future use, or iii) controlling the industrial output device via an output port of the industrial controller device.

### BRIEF DESCRIPTION OF THE DRAWINGS

FIG. 1 is a diagram of an example industrial system in which an industrial controller device may be utilized, according to an embodiment.

FIG. 2 illustrates views of an industrial controller device, according to an embodiment.

FIG. 3 is a diagram of a graphical user interface that may be displayed on a display of an industrial controller device to provide a main menu to a user, according to an embodiment.

FIG. 4 is a diagram of a graphical user interface that may be displayed on a display of an industrial controller device to provide a system setup menu to a user, according to an embodiment.

FIG. 5 is a diagram of a graphical user interface that may be displayed on a display of an industrial controller device to provide an analog sensor setup menu to a user, according to an embodiment.

FIG. 6 is a diagram of a graphical user interface that may be displayed on a display of an industrial controller device to provide a discrete I/O configuration menu to a user, according to an embodiment.

FIG. 7 is a diagram of a graphical user interface that may be displayed on a display of an industrial controller device to provide a stacklight setup menu to a user, according to an embodiment.

FIGS. 8-10 are diagrams of example graphical user interfaces that may be displayed on a display of an industrial controller device to provide various views of sensor measurement data, according to embodiments.

FIGS. 11 and 12 are diagrams of example graphical user interfaces that may be displayed on a display of an industrial controller device to enable a user to provide configuration information for monitoring and/or control of different industrial output devices, according to an embodiment.

FIGS. 13 and 14 are diagrams of example graphical user interfaces that may be displayed on a display of an industrial controller device to enable a user to provide configuration information for monitoring and/or control of a particular industrial output device, according to an embodiment.

FIG. 15 is a flow diagram of an example method for operating an industrial controller device, according to an embodiment.

### DETAILED DESCRIPTION

According to embodiments of the present disclosure, an industrial controller device is equipped with a display device configured to display, to a user, a graphical user interface that allows the user to easily configure monitoring and/or control to be performed by the industrial controller device by providing sensor and other configuration information via graphical elements (e.g., pull-down menus, checkboxes, text boxes, etc.) displayed on the graphical user interface to the user. The industrial controller device may include one or more input ports configured to couple with analog and/or digital sensors that may, in turn, be coupled with industrial output devices and may be configured to measure various parameters associated with operation of the industrial output devices. The industrial controller device may also include one or more output ports that may be coupled with the industrial output devices to allow the industrial controller device to control the industrial output devices. The industrial controller device may further include a processor, such as a programmable logic device (PLD), coupled to the one or more input ports and the one or more output ports of the industrial controller device. The processor may be configured to receive and process signals from sensors coupled with the one or more input ports of the industrial controller device and to generate and provide control signals to the one or more output ports of the industrial controller device to control the industrial output devices coupled with the industrial controller device.

In an embodiment, the user may plug in one or more sensors into one or more input ports of the industrial controller device and may use the graphical user interface displayed to the user on the display device to configure the industrial controller device to obtain sensor signals from the one or more sensors plugged into the input ports of the industrial controller device and to perform actions, such as provide alarms and/or generate control signals, based on the sensor measurements obtained from the one or more sensors plugged into the one or more input ports of the industrial controller device. In an example, the graphical user interface displayed to the user on the display of the industrial controller device may allow the user to associate the input ports of the industrial controller device with types of sensors plugged into the input ports, to provide sensor information such as units of measurement and measurement ranges of the sensors, and to set limits or thresholds for monitoring parameters of the industrial output devices using sensor signals acquired from the sensors. The graphical user interface may be configured to display graphical elements, such as pull-down menus, boxes, buttons, etc., via which the user may select or otherwise enter a type of a sensor, a unit of measurement of the sensor, etc. plugged into an input port of the industrial controller device. The graphical user interface may also display graphical elements to request configuration information, such as limits or thresholds, for monitoring measurement values of the sensor plugged into the input port and indications of actions to be performed by the industrial controller device when the measurement value meet monitoring conditions provided via the graphical user interface by the user.

The industrial controller device may use the sensor information and the configuration information provided by the user via the graphical user interface to monitor the industrial output device, to collect sensor measurement data during operation of the industrial output device, to save the sensor measurement data locally and/or transmit the data to a server, and to perform actions specified by the user via the graphical user interface, such as providing an alarm and/or controlling the industrial output device when a measurement obtained via the sensor exceeds or is below a threshold as configured by the user. These and other techniques described herein allow users to easily and quickly configure or re-configure the industrial controller device to perform monitoring and/or control of specific industrial output devices and according to the specific applications of interest to the user. In embodiments, the configuration and/or re-configuration for monitoring specific industrial output devices may be performed without requiring any programming code or scripts to be written (e.g., in a programming language such as Python, C, Ladder Logic, etc.) for setting up monitoring of the specific industrial output devices. Thus, for example, the configuration and/or re-configuration may be easily performed in situations in which personnel skilled in writing programming code may not be available, such as at a small manufacturing plant. This allows for deployment of the industrial controller device in situations and use cases where such monitoring or control of industrial output devices is not feasible with conventional industrial controller devices that need to be programmed using programming code written for specific industrial output devices and specific use cases and applications.

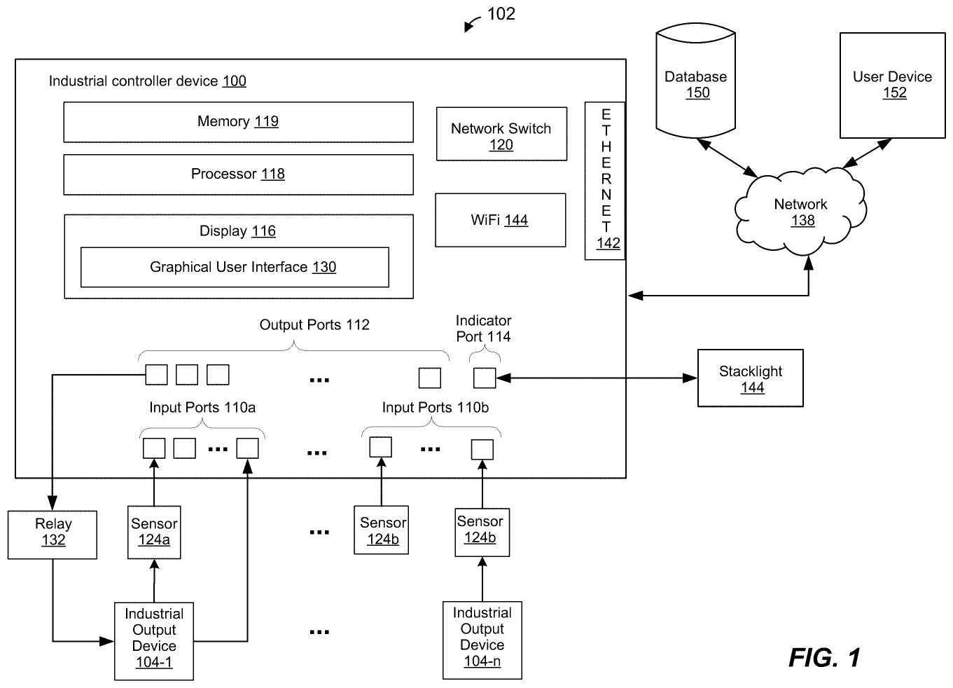

FIG. 1 is a diagram of an example industrial system 102 in which an industrial controller device 100 according to an embodiment of the present disclosure may be utilized. The industrial controller device 100 may be installed or otherwise disposed at a manufacturing plant and may be used for monitoring and/or controlling industrial output devices 104 at the manufacturing plant. The manufacturing plant may be a relatively small manufacturing facility. For example, the manufacturing plant may be equipped to perform a single process (e.g., welding, mixing, etc.) and/or to produce relatively few types of products. In an example, the manufacturing plant may be equipped with a relatively small number of industrial output devices 104, such as only one or several industrial output devices 104. In other examples, industrial controller device 100 may be installed or otherwise disposed at a medium-size or a large manufacturing plant.

The industrial output devices 104 may include, but not limited to, welders, powder mixers, drills, computer numeric control (CNC) machines, etc. In some examples, the industrial output devices 104 may include a plurality of industrial output devices of a same type. As just an example, the industrial controller device 100 may be installed at a welding plant, and the industrial output devices 104 may include several welders employed at the welding plant. As another example, the industrial controller device 100 may be installed at a mixing plant, and the industrial output devices 104 may include several mixers (e.g., powder mixers) employed at the mixing plant. In other examples, the industrial output devices 104 may include industrial output devices of different types. As just an example, a first industrial output device 104 may be a welder employed at a manufacturing plant and a second industrial output device 104 may be a CNC machine employed at the manufacturing plant.

The industrial controller device 100 may include one or more input ports 110, one or more output ports 112, and an indicator output port 114. The industrial controller device 100 may also include a display device 116 and a processor 118. The processor 118 may be coupled with (e.g., wired to) each of the one or more input ports 110, each of the one or more output ports 112, and the indicator output port 114. The processor 118 may also be coupled with the display device 116. In an example, the industrial controller device 100 may include a network switch 120 configured to provide the coupling between the processor 118 and the display device 116. The network switch 120 may be configured to route signals and other data between the processor 118 and the display device 116. In an embodiment, the display device 116 may be an Human Machine Interface (“HMI”) device that may include a separate HMI processor, and the network switch 120 may be configured to route signals and other data between the processor 118 and the HMI processor.

The one or more input ports 110 may include one or more analog input ports 110a and/or one or more digital input ports 110b. The analog input ports 110a may be configured to couple with analog sensors 124a. The analog sensors 124a may, in turn, be coupled with (or be a part of) one or more industrial output devices 104 and may be configured to measure parameters of the one or more industrial output devices 104. The analog sensors 124a may include, for example, current sensors configured to measure current drawn by an industrial output device 104 during operation of the industrial output device 104, vibration sensors configured to measure vibration of a part (e.g., a motor, a polishing wheel, etc.) of an industrial output device 104 during operation of the industrial output device 104, temperature sensors, water clarity sensors, pressure sensors, etc. The digital sensors 124b may include, for example, buttons, presence sensors, tilt sensors, etc. Generally, the analog sensors 124a are configured to measure parameters that may continuously vary within a certain range. For example, an analog current sensor 124a may be configured to measure current draw of an industrial output device 104 by generating a 4-20 mA sensor signal corresponding to, for example, 0 to 50 A current draw range. On the other hand, digital sensors 124b may be configured to detect states of variables having discrete values, such as On or Off states or presence or absence states. For example, a digital sensor 124b may be configured to detect whether an industrial output device 104 is turned on or off or to detect when each part made by an industrial output device 104 enters a conveyor belt (e.g., to detect completion of manufacture of the part and/or to count a number of parts completed by the industrial output device 104). In some example, an analog sensor 124a may be configured to detect certain On or Off states. For example, an analog sensor 124a may be used to detect whether an industrial output device 104 is turned On or turned Off, in some embodiments.

The industrial controller device 100 may be configured provide a graphical user interface 130 to a user on the display device 116. The graphical user interface 130 may allow the user to configure monitoring and/or control of industrial output devices 104 coupled with the industrial controller device 100. In an embodiment, the user may plug in a sensor 124 into an input port 110 of the industrial controller device 100 and may use the graphical user interface 130 displayed to the user on the display device 116 to configure the industrial controller device 100 to obtain measurements from the sensor 124 and to perform actions, such as provide alarms and/or generate control signals, based on the measurements obtained from the sensor 124. In an example, the processor 118 is configured to request and receive, via the graphical user interface 130 displayed to the user on the display device 116, information regarding the sensor 124 plugged into the input port 110. For example, the processor 118 may be configured to request and receive, via the graphical user interface 130 displayed to the user on the display device 116, an indication of a type of sensor 124 plugged into the input port 110. The user may thus specify, via the graphical user interface 130, the type of sensor 124 plugged into the input port 110, thereby associating the type of the sensor 124 with the input port 110 into which the sensor 124 is plugged in. In an example, the information regarding the sensor 124 requested by the processor 118 via the graphical user interface 130 includes a unit of measurement (e.g., amperes (Amp), Celsius (° C.), Fahrenheit (° F.), Hertz (Hz), microsiemens (μS), pascals (Pa). etc.) of the sensor 124. In some examples, the information regarding the sensor 124 requested by the processor 118 via the graphical user interface 130 further includes a measurement range of the sensor 124. The graphical user interface 130 may be configured to display a graphical element, such as a pull down menu, to allow the user to select or otherwise enter the unit of measurement and/or the measurement range of the sensor 124.

As just an example, in the case that the sensor 124 is a current sensor, the user may select or otherwise enter “Amps” as the unit of measurement of the sensor 124. The user may additionally select or otherwise enter a measurement range of the sensor 124, such “0 to 20 Amps” or “0 to 50 Amps,” for example. As described in more detail below, in some embodiments, the graphical user interface 130 may additionally be configured to allow the user to provide a custom calibration value for the sensor 124. For example, the graphical user interface 130 may display a box or other suitable interactive graphical element to allow the user to enter the custom calibration value. The custom calibration value may be used specify a custom, or non-standard, measurement range of the sensor 124. In some examples, the graphical user interface 130 may be configured to display a formula for calculating the calibration value. As an example, the formula displayed to the user via the graphical user interface 130 may be “1000/(maximum range of the sensor). In other examples, other suitable formulas and/or other suitable methods of specifying a custom calibration value may be used.

For a digital sensor 124b, no unit of measurement or measurement range may be required. Accordingly, for a digital sensor 124b plugged into a digital input port 110b, the processor 118 may be configured to display the sensor value read from the digital sensor 124b to the user via the user interface 130 without requesting any further information from the user.

In some embodiments, the processor 118 may be configured to detect when a sensor 124 is plugged into an input port 110, and may request, via the graphical user interface 130, the information regarding the sensor 124 in response to detecting that the sensor 124 is plugged into the input port 110. In an embodiment, the sensor 124 may include or be coupled with a mating connector, configured to mate with a connector of the input port 110, wired such that a short circuit is made between two specific pins of the mating connector. In this example, the processor 118 may be configured to detect that the sensor 124 is plugged into the input port 110 by detecting that a short circuit has been made between the two specific pins on the connector of the input port 110. In other examples, the processor 118 may be configured to detect that a sensor 124 is plugged into an input port 110 is other suitable manners. The processor 118 may be configured to, in response to detecting that a sensor 124 is plugged into an input port 110, cause the graphical user interface 130 including graphical elements for requesting the sensor information regarding the sensor 124 to be displayed on the display device 116. In some embodiments or scenarios, for example when a user plugs in a sensor 124 with a mating connector that has not been wired such that a short circuit is made between the two specific pins, the user may manually access the graphical user interface 130 having graphical elements for providing the information regarding the sensor 124, for example by selecting sensor setup in a main menu displayed to the user via the graphical user interface 130.

In an embodiment, the processor 118 is configured to acquire sensor signals from the sensor 124 via the input port 110 and to generate sensor measurement data based on i) the sensor information provided by the user via the graphical user interface 130 and ii) the sensor signals acquired from the sensor 124 via the input port 110. For example, the processor 118 may be configured to convert values of the sensor signals acquired from the input port 110 to sensor measurement values based on the range of the sensor 124 provided by the user via the graphical user interface 130. The graphical user interface 130 may further be configured to allow the user to set monitoring conditions for monitoring one or more parameters (e.g., current draw, temperature, pressure, vibration velocity, humidity, etc.) of the industrial output device 104 based on the sensor signals, and actions to be performed when the sensor values meet the monitoring conditions. For example, the user may enter, via the graphical user interface 130, minimum and/or maximum thresholds for one or more of i) a normal condition corresponding to normal operation of the industrial output device 104, ii) a warning condition and iii) an alarm condition. The user may also indicate, via the graphical user interface 130, how the user wishes to receive warnings and/or alarms. For example, the graphical user interface 130 may be configured to present to the user several selectable alarm options and may allow the user to select one or more of the presented alarm options via the graphical user interface 130. The alarm options may include, for example, providing the alarm via one or more of a message displayed on the display device 116, providing the alarm via the stacklight 144 (e.g., by causing the stacklight 144 to light red and/or by buzzing a buzzer that may be included with the stacklight 144), via an e-mail sent to the user, via a text message sent to a device of the user, etc.

In various embodiments, the processor 118 may be configured to, based on sensor signals acquired from a digital sensor 124b coupled to a digital port 110b, perform one of i) determine when a part is made by an industrial output device 104, ii) count a number of parts produced by the industrial output device 104, or iii) calculate overall equipment efficiency (OEE) of an industrial output device 104.

In some embodiments, the graphical user interface 130 may be configured to allow the user to specify conditions for when and how to control the industrial output device 104 via an output digital port 112. For example, the user may indicate, via the graphical user interface 130, that the action to be performed when a certain monitoring condition is met is controlling the industrial output device 104, for example to turn on or to turn off at least a portion of the industrial output device 104 by triggering a relay 132 that may be coupled to the output digital port 112. Triggering the relay may cause power to be cut off from at last a portion of the industrial output device 104 or to be provided to the at least the portion of the industrial output device 104. The relay 132 may be provided as a device external to the industrial controller device 100 as shown in FIG. 1, or may be integrated with the industrial controller device 100, in various embodiments. In some examples, controlling the industrial output device 104 via the digital output port 112 may include controlling various parts, such as one or more of a motor, a pump, a fan, an actuator, a heater, a valve, etc., included in or otherwise associated with operation of the industrial output device 104. In some embodiments, one or more external relays 132 may be provided in a kit together with the industrial controller device 100. In some example, one or more sensors 124 may be provided in a kit together with the industrial controller device 100 in addition to or instead of one or more external relays 132 being included in the kit. In other example, the industrial controller device 100 may be provided individually and not as part of a kit.

In some embodiments, the industrial controller device 100 may additionally include one or more communication interfaces configured to communicatively couple the industrial controller device 100 to a communication network 138. The communication network 138 may be a single network or may include multiple networks. For example, the communication network 138 may include a wireless network, e.g., Wi-Fi, WLAN, cellular (5G, 4G, LTE/A), and/or a wired network, e.g., Ethernet. In an example, the one of more communication interfaces of the industrial controller device 100 may include an Ethernet communication interface 142 configured to couple the industrial controller device 100 to the Ethernet and a Wi-Fi communication interface 144 configured to couple the industrial controller device 100 to a Wi-Fi network. In an embodiment, the Ethernet communication interface 142 and the Wi-Fi communication interface 144 may be coupled to the processor 118 via the network switch 120. The network switch 120 may be configured to route signals between i) the processor 118 and ii) the Ethernet communication interface 142 and the Wi-Fi communication interface 144.

The processor 118 may thus be configured to communicate with external devices, such as a database 150 and a user device 152 via the communication network 138. The database 150 may comprise an external storage device (e.g., housed on a server) that may be configured to receive and store data (e.g., sensor measurement data) collected or otherwise acquired by the industrial controller device 100. The user device 152 may be, for example, a personal device via which a user may communicate with the industrial controller device 100, for example to receive alarms, sensor measurement data, etc. from the industrial controller device 100 and/or provide configuration information to the industrial controller device 100. Examples of a user device 152 include, but are not limited to, a desktop computer, laptop, tablet, and smart phone.

In some embodiments, the user may access the industrial controller device 100 via the user device 152 over the communication network 138. For example, the user may be able to provide sensor information and/or configuration information to the industrial controller device 100 via graphical user interfaces (e.g., same as or similar to the graphical user interface 130) that may be displayed to the user on a display of the user device 152. The user may thus remotely configure and/or reconfigure operation of the industrial controller device 100 over the communication network 138. As just an example, the user may remotely configure or adjust various limits or thresholds for monitoring and/or controlling industrial output devices 104 over the communication network 138.

In some embodiments, the processor 118 may also be configured to obtain remote sensor data via one or more remote sensors via the Ethernet communication interface 142 and/or the Wi-Fi communication interface 144. The remote sensor data may be provided by digitally equipped industrial output devices 104, for example. The remote sensor data may be transmitted from an industrial output device 104 and may be received by the processor 118 using a suitable communication protocol, such as the Modbus protocol, the Message Queuing Telemetry Transport (MQTT) protocol, or the Ethernet Internet Protocol (Ethernet/IP), for example. For example, the processor 118 may be configured to support each of the Modbus protocol, the MQTT protocol, and Ethernet/IP. In other examples, the processor 118 is configured to additionally or alternatively support other suitable communication protocols. In an embodiment, the processor 118 is configured to obtain remote sensor information from a user via the graphical user interface 130. The remote sensor information provided by the user via the graphical user interface 130 may include an address (e.g., an internet protocol (IP) address) of the remote sensor and, in some cases, login credentials, such as username and password, to be used for connecting with the remote sensor. The remote sensor information provided by the user via the graphical user interface 130 may also include an indication of a communication protocol (e.g., selected from among Modbus, MQTT, and Ethernet/IP) to be used for communication with the remote sensor. The processor 118 may be configured to then begin acquiring the remote sensor data using the remote sensor configuration provided by the user via the graphical user interface 130. The remote sensor data may be used by the processor 118 for monitoring and/or controlling industrial output devices 104 in the same or similar manners as the sensor data acquired by the processor 118 from the sensors 124 coupled with input ports 110, in various embodiments.

It is noted that although the industrial controller device 100 is described herein as including one or more communication interfaces for connecting to a communication network, the industrial controller device 100 may, in some embodiments or scenarios, operate independently without being connected to a communication network. For example, the industrial controller device 100 may be deployed at a facility (e.g., a small manufacturing facility) that does not have a communication network, and thus the industrial controller device 100 may operate at the facility independently without being connected to any communication network.

The processor 118 may be configured to use the configurations and thresholds provided by the user via the graphical user interface 130 to monitor the industrial output devices 104, to collect sensor measurement data (e.g., from sensors coupled with input ports 110 and/or from remote sensors coupled to the coupled to the industrial controller device 100 over the communication network 138) during operation of the industrial output devices 104, to save data locally in a memory 119 that may be coupled to the processor 118 and/or transmit the data via the communication network 138 to the database 150 and/or the user device 152. The processor 118 may also be configured to perform actions specified by the user, such as providing an alarm and/or controlling the industrial output device when a measurement obtained via the sensor exceeds or is below a threshold as configured by the user. As just an example, a user may, via the graphical user interface 130, configure the industrial controller device 100 to monitor a current draw of an industrial output device (e.g., current draw of a pump) 104 and, if the current draw goes above a certain limit, to trigger a relay 132 to turn off the industrial output device 104 and to provide an alarm to a user (e.g., via the stacklight 144). In this case, if the industrial output device 104 malfunctions (e.g., due to the pump being clogged), the current draw of the industrial output device 104 will go above the certain limit, causing the industrial controller device 100 to trigger the relay and turn off the industrial output device 104. The malfunction of the industrial output device 104 may then be addressed before the malfunction causes damage to the industrial output device 104. As just another example, a user may, via the graphical user interface 130, configure the industrial controller device 100 to monitor a temperature of an industrial output device 104 and, if the temperature rises above a certain limit, to trigger a relay 132 to turn off a heater that may be included in, or provided in the vicinity of, industrial output device 104. The user may also configure, via the graphical user interface 130, the industrial controller device 100 to trigger the relay 132 to turn the heater on if the temperature falls below a certain limit. The temperature of the industrial output device 104 may thus be properly maintained without overheating and potentially damaging the industrial output device 104. In other examples, the user may configure the industrial output device to monitor other parameters and to use other control conditions so that industrial output devices 104 are properly operated and maintained.

These and other techniques described herein allow users to easily and quickly configure or re-configure the industrial controller device 100 to perform monitoring and/or control of specific industrial output devices 104 and according to specific use cases and applications of interest to the user. For example, the user may re-configure the industrial controller device 100 to change out a sensor 124 coupled with an input port 110 for a different sensor by simply unplugging the old sensor 124 from the input port 110, plugging the new sensor 124 into the input port 110, and using the graphical user interface 130 to provide sensor and configuration information to configure the industrial controller device 100 to perform monitoring and/or control based on sensor signals acquired via the input port 110 from the new sensor 124. As just another example, the user may use the graphical user interface 130 to adjust various limits or thresholds to be used by the industrial controller device 100 for monitoring and/or controlling an industrial output device coupled with the industrial controller device 100. In embodiments, the configuration and/or re-configuration for monitoring specific industrial output devices 104 may be performed without requiring any additional programming code or scripts to be written for setting up monitoring of the specific industrial output devices 104. Thus, for example, the configuration and/or re-configuration may be easily performed in situations in which personnel skilled at writing programming code may not be available, such as at a small manufacturing shop or plant. This allows for deployment of the industrial controller device 100 in situations and use cases where such monitoring or control of industrial output devices is not feasible with conventional industrial controller devices that need to be programmed using code written in a programming language, such as Python, C, Logic Ladder, etc., for specific industrial output devices and specific use cases and applications.

The industrial controller device 100 may thus be used to monitor and/or control industrial output devices in industrial systems in which use of traditional controller that need to be programmed using a programming language, such as Python, C, Logic Ladder, etc., may not be feasible, such as at small manufacturing shops or plants that may lack personnel with specialized programming skills, for example. Use of the industrial controller device 100 in such environments may allow an operator of a small manufacturing shop or plant to increase efficiency of the industrial output devices, prolong life of the industrial output devices, reduce or eliminate downtime and cost associated with repairing and downtime of the industrial output devices, etc., in at least some embodiments.

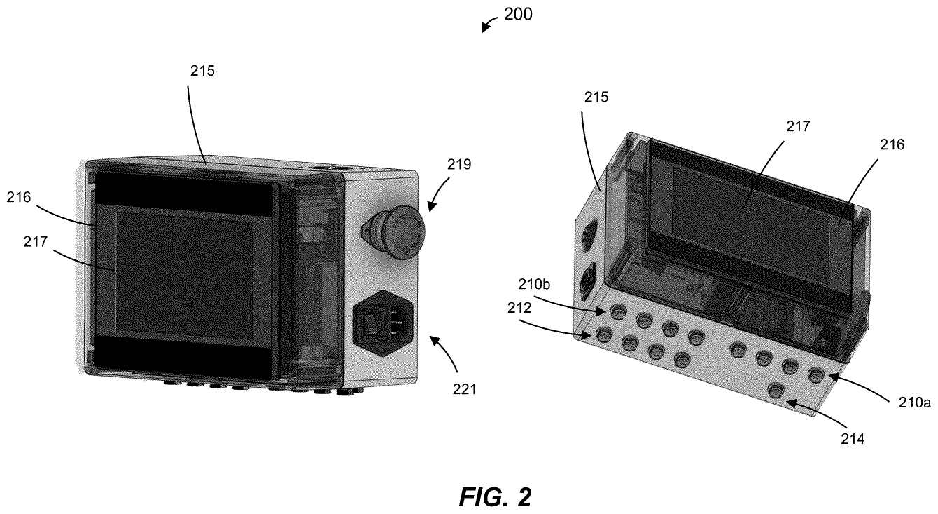

FIG. 2 illustrates views of an industrial controller device 200, according to an embodiment. The industrial controller device 200 corresponds to the industrial controller device 100 of FIG. 1, in an embodiment. The industrial controller device 200 includes like-numbered elements with the industrial controller device 100 that may be the same as or similar to the corresponding elements that are described above in connection with FIG. 1. The industrial controller device 200 includes a plurality of analog input ports 210a corresponding to the analog input ports 110a of the industrial controller device 100 of FIG. 1 and a plurality of digital input ports 210b corresponding to the digital input ports 110b of the industrial controller device 100 of FIG. 1. For example, the industrial controller device 200 includes four analog input ports 210a and four digital input ports 210b, in the illustrated embodiment. The industrial controller device 200 also includes a plurality of digital output ports 212 corresponding to the digital output ports 112 of the industrial controller device 100 of FIG. 1 and an indicator output port 214 corresponding to the indicator output port 114 of the industrial controller device 100 of FIG. 1. For example, the industrial controller device 200 includes four digital output ports 212 and a single indicator output port 214, in the illustrated embodiment. In other examples, the industrial controller device 200 may include other number of input ports 210, output ports 212 and/or indicator output ports 214.

The plurality of analog input ports 210a, the plurality of digital input ports 210b, the plurality of digital output ports 212, and the indicator output port 214 may be provided in a housing 215 of the industrial controller device 200. The plurality of analog input ports 210a and the plurality of digital input ports 210b may be grouped together in respective groups of ports on a surface (e.g., the bottom surface) of the housing 215 of the industrial controller device 200. Similarly, the plurality of digital output ports 212 may be grouped together in a group of ports on the surface (e.g., the bottom surface) of the housing 215 of the industrial controller device 200. The group of digital input ports 210b and the group of digital output ports 212 may be provided on a same side (e.g., the left side) of the surface of the housing 215 of the industrial controller device 200. The group of analog input ports 210b may be provided on the other side (e.g., the right side) of the surface of the housing 215 of the industrial controller device 200. Such features of the industrial controller device 200 may improve usability of the industrial controller device 200, in at least some embodiments.

The industrial controller device 200 further includes a display device 216 corresponding to the display device 116 of the industrial controller device 100 of FIG. 1. The display device 116 may be an HMI device and may include an HMI processor (not shown in FIG. 2) and a screen 217. The screen 217 of the display device 116 may be a touch screen, for example. The screen 217 of the display device 116 may be a color screen. In other examples, other suitable types of display devices and/or other suitable types of screens may be used. The display device 216 may be integrated with the industrial controller device 200 and is packaged within the housing 215 of the industrial controller device 200. The display device 216 may be configured to display a graphical user interface (e.g., the graphical user interface 130 of FIG. 1) that may enable a user to input sensor information regarding sensors (e.g., the sensors 124a, 124b of FIG. 1) coupled with the input ports 210a, 210b or remote sensors that may be coupled to the industrial controller device 200 via an Ethernet or Wi-Fi communication network, where the sensors may be configured to measure parameters parameter (e.g., current draw, temperature, vibration, etc.) of industrial output devices (e.g., the industrial output devices 104 of FIG. 1).

The graphical user interface may additionally allow the user to enter configuration information, such as various limits, thresholds, etc. to configure the industrial controller device 200 to perform various actions based on measurements obtained by the industrial controller device 200 from the sensors. The actions may include, for example, determining status of the industrial output devices based on values of the parameters measured by the sensors, to generate alarms, to provide indications of the status and/or the alarms to the user, etc. The actions may also include controlling the industrial output devices via the digital output ports 214 according to the configuration information provided by the user via the graphical user interface. For example, an action performed by the industrial controller device 200 may be triggering a relay device coupled with a digital output port 212 to turn off at least a portion of an industrial output device when a parameter (e.g., current draw, temperature, vibration, etc.) measured by the sensor exceeds a threshold provided by the user.

The industrial controller device 200 may include additional features that make the industrial controller device 200 suitable for operation in industrial environments. For example, the industrial controller device 200 may include an emergency stop (E-stop) button 219 configured to shot off all outputs of the industrial controller device 200 in an emergency situations. The E-stop 219 may be required to meet Occupational Safety and Health Administration (OSHA) control system regulations. In some embodiments, the industrial controller device 200 may omit the E-stop 219. In an example, the industrial controller device 200 may include a function button, which may be a physical momentary push button, in addition to or in place of the E-Stop 219. The momentary push button may be configurable, via the graphical user interface provided on the display device 216, to be used as a digital input. The momentary push button may thus be used to trigger an action, such as increasing or decreasing a part count, a start button, a reset button, etc. In some examples, the momentary push button may be used instead of a graphical element displayed via the graphical user interface on the display device 216. Such physical push button may be useful, for example, in situations in which the user may be wearing gloves and or may have greasy fingers that would prevent the user from being able to use the graphical user interface on the on the display device 216 (e.g., a touch screen).

As another example, the industrial controller device 200 may include an AC power input 221 that may include an AC fuse to protect the industrial controller device 200 and enhance safety of the operator of the industrial controller device 200. In an embodiment, the industrial controller device 200 may be equipped with an exhaust fan to allow the industrial controller device 200 to operate over higher temperatures. In other examples, other industrial enhancements may be additionally or alternatively provided to ensure the industrial controller device 200 is suitable for operation in various industrial environments.

With continued reference to FIG. 2, the industrial controller device 200 may also include a controller processor (not shown in FIG. 2) that may correspond to the processor 118 of the industrial controller device 100 of FIG. 1. The controller processor may be packaged within the housing 215 of the industrial controller device 200 and may be internally wired to or otherwise coupled with each of the analog input ports 210a, each of the digital input ports 210b, each of the digital output ports 212, and the indicator output port 214. The controller processor may be configured to acquire signals from sensors (e.g., the sensors 124a, 124b of FIG. 1) coupled with the input ports 210a, 210b, where the sensors may be configured to measure parameters of industrial output devices (e.g., the industrial output devices 104 of FIG. 1). The parameters, may include, for example, one or more of i) a current draw of the industrial output device, ii) an operating temperature of the industrial output device, iii) a pressure experienced by at least a portion of the industrial output device, iv) a vibration experienced by at least a portion of the industrial output device, etc.

The controller processor may also be configured to generate sensor measurement data based on sensor information provided by the user via the graphical user interface displayed to the user on the screen 217 of the display device 216, and to perform actions with respect to the sensor measurement data according to various configurations provided by the user via the graphical user interface displayed to the user on the screen 217 of the display device 216. For example, the controller processor may display the sensor measurement data to the user on the screen 217 of the display device 216 and/or may save the measurement in a local memory for future use. In cases where the industrial controller device is connected to a communication network, the controller processor may cause the sensor measurement data to be transmitted, for example to a remote database (e.g., the database 150 of FIG. 1) and/or to a user device (e.g., the user device 152 of FIG. 1), via the communication network (e.g., the communication network 138 of FIG. 1). The controller processor may additionally or alternatively monitor states of parameters measured by sensors coupled with the input ports 210a, 210b based on monitoring conditions (e.g., various limits or thresholds) provided by the user via the user graphical interface displayed to the user on the screen 217 of the display device 216. The controller processor may cause indications of the states be provided to the user, for example by displaying the indications of the states on the graphical user interface displayed to the user on the screen 217 of the display device 216 and/or generating and providing control signals to the indicator output port 214 to cause the indications to be provided to the user via an indicator device (e.g., a stacklight) coupled with the indicator output port 214. These and other features of the industrial controller device 200 enable users to quickly, intuitively, and efficiently configure operation of the industrial controller device 200 for the particular use cases of the users, without having to employ any special personnel, such as a software or a system integration engineer, to set up monitoring and/or control of the industrial output devices, in various embodiments.

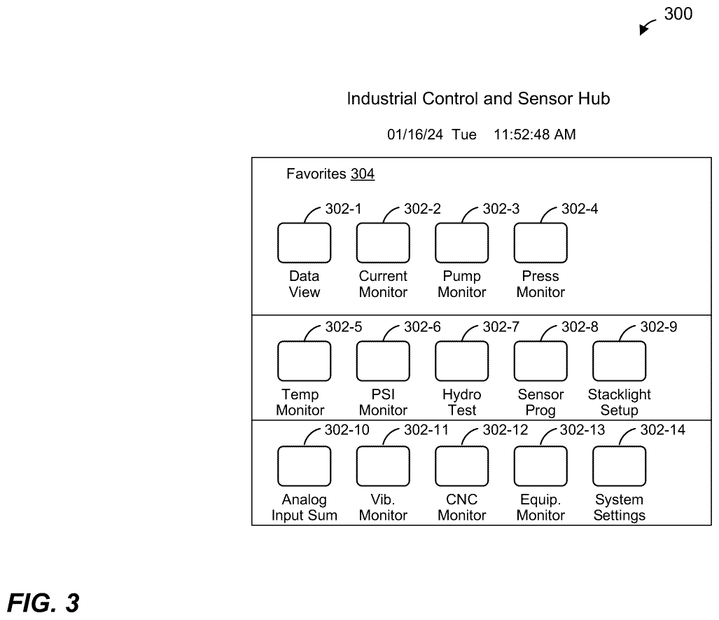

FIG. 3 is a diagram of a graphical user interface (sometimes referred to herein as “main menu graphical user interface”) 300 configured to provide a main menu to a user, according to an embodiment. The graphical user interface 300 may correspond to the graphical user interface 130 of the industrial controller device 100 of FIG. 1, and the graphical user interface 300 is described below in connection with the industrial controller device 100 of FIG. 1. In other embodiments, however, the graphical user interface 300 may be used with a suitable industrial controller device different from the industrial controller device 100 of FIG. 1 and/or in suitable industrial process systems different from the industrial system 102 of FIG. 1. Similarly, the industrial controller device 100 of FIG. 1 may be configured to display a main menu graphical user interface different from the graphical user interface 300, in some embodiments.

The main menu graphical user interface 300 may include a plurality of icons 302 corresponding to various applications that may be provided on the industrial controller device 100. The icons 302 may include a data view icon 302-1, a current monitor icon 302-2, a pump monitor icon 302-3, a press monitor icon 302-4, a temperature monitor icon 302-5, a PSI monitor icon 302-6, a hydro test icon 302-7, a sensor configuration icon 302-8, a stacklight setup icon 302-9, an analog input sum icon 302-10, a vibration monitor icon 302-11, a CNC monitor icon 302-12, an equipment monitor icon 302-13, and a systems settings icon 302-14. In other embodiments, the icons 302 may exclude one or more of the icons 302-1-302-14 illustrated in FIG. 3 and/or may include one or more additional icons, corresponding to one or more additional applications, not illustrated in FIG. 3.

The main menu graphical user interface 300 may allow the user organize the display of the icons 302, for example according to frequency with which the user accesses or expects to access the various applications. For example, the graphical user interface 300 may allow the user to designate one or more of the applications as favorite applications that may include more frequently used and/or more important applications such that icons corresponding to these applications are displayed, for example, in a favorites panel 304 of the graphical user interface 300. In an example, the graphical user interface 300 may allow the user to drag icons 302 into the favorites panel 304 or to other specify icons 302 to be displayed in the favorites panel 304. In another example, the favorite application may comprise the most commonly used applications based on previous users feedback. In this case, dragging of the icons 302 or other manipulations to manually move the icons 302 may not be provided via the main menu graphical user interface 300.

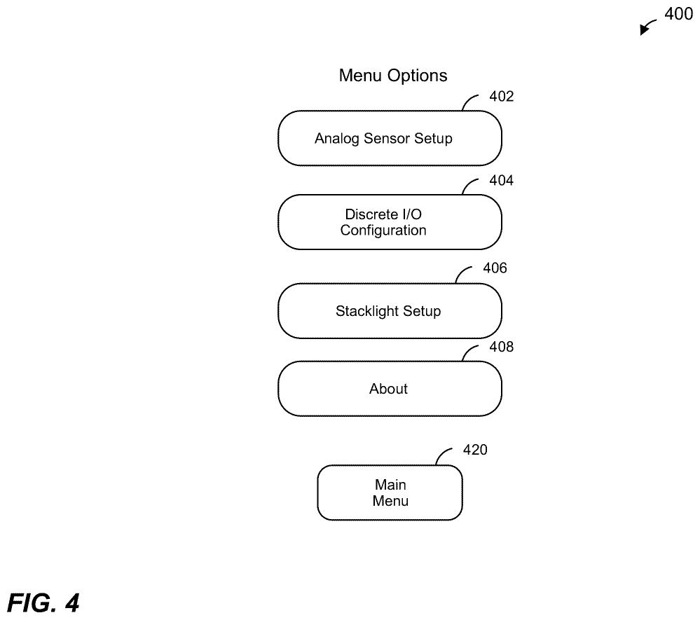

FIG. 4 is a diagram of a graphical user interface (sometimes referred to herein as “system setup graphical user interface”) 400 configured to provide a system setup menu to a user, according to an embodiment. The graphical user interface 400 may correspond to the graphical user interface 130 of the industrial controller device 100 of FIG. 1, and the graphical user interface 400 is described below in connection with the industrial controller device 100 of FIG. 1. In other embodiments, however, the graphical user interface 400 may be used with a suitable industrial controller device different from the industrial controller device 100 of FIG. 1 and/or in suitable industrial process systems different from the industrial system 102 of FIG. 1. Similarly, the industrial controller device 100 of FIG. 1 may be configured to display a system setup graphical user interface different from the graphical user interface 400, in some embodiments.

The system setup graphical user interface 400 may be displayed to the user when the user selects the system setup icon 302 of the main menu graphical user interface 300, for example. The graphical user interface 400 may include a plurality of graphical elements (e.g., icons or buttons) that allow the user to select from among various applications for setting up various system configurations. For example, the graphical user interface 400 may include an analog sensor setup button 402, a discrete input output (I/O) configuration button 404, and a stacklight setup button 406. The system setup graphical user interface 400 may additionally include an about button 408 and a main menu button 420.

The analog sensor setup button 402 may allow the user to pull up a menu for setting up analog sensors coupled with analog input ports 110a. The discrete I/O configuration button 404 may allow the user to pull up a menu for setting up discrete inputs coupled with the digital input ports 110b and/or configured controls to be provided via digital output ports 112. The stacklight setup button 406 may allow the user to pull up a menu for setting up indications to be provided via a stacklight coupled with the indicator output port 114. The about button 408 may allow the user to pull up information about the configuration of the industrial controller device, such as a version of software running of the industrial controller device. The main menu button 420 may allow the user to pull up (e.g., to return to) a main menu user interface, such as the main menu graphical user interface 300 of FIG. 3.

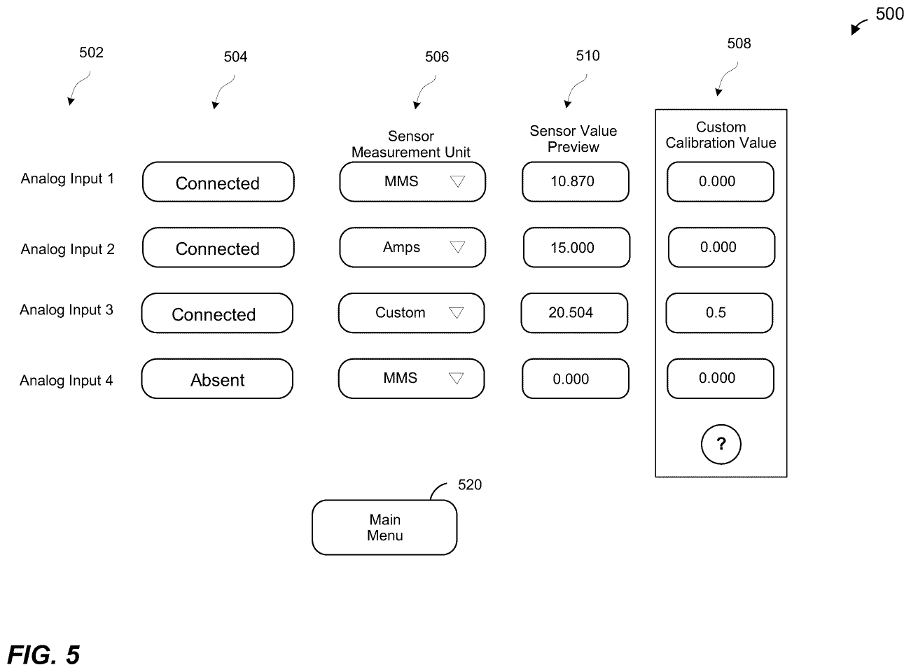

FIG. 5 is a diagram of a graphical user interface (sometimes referred to herein as “analog sensor setup graphical user interface”) 500 configured to provide an analog sensor setup menu to a user, according to an embodiment. The graphical user interface 500 may correspond to the graphical user interface 130 of the industrial controller device 100 of FIG. 1, and the graphical user interface 500 is described below in connection with the industrial controller device 100 of FIG. 1. In other embodiments, however, the graphical user interface 500 may be used with a suitable industrial controller device different from the industrial controller device 100 of FIG. 1 and/or in suitable industrial process systems different from the industrial system 102 of FIG. 1. Similarly, the industrial controller device 100 of FIG. 1 may be configured to display an analog sensor setup graphical user interface different from the graphical user interface 500, in some embodiments.

The analog sensor setup graphical user interface 500 may include a plurality of groups (e.g., rows) 502 of graphical elements that allow the user to provide sensor information for a plurality of analog sensors coupled with respective analog input ports 110a of the industrial controller device 100. Thus, for example, in an embodiment in which the industrial controller device 100 includes four analog input ports 110a, the analog sensor setup graphical user interface 500 includes four rows 502 of graphical elements respectively corresponding to respective ones of the four analog input ports 110a. Each of the rows 502 of graphical elements corresponds to a particular analog port 110a and includes a connection indicator graphical element 504 corresponding to the particular analog port 110a, a sensor measurement unit graphical element 506 corresponding to the particular analog port 110a, a sensor value preview graphical element 508 corresponding to the particular analog port 110a, and a custom calibration value graphical element 510 corresponding to the particular analog port 110a.

The connection indicator graphical element 504 may comprise a toggle button configured to indicate whether a sensor is coupled with (e.g., plugged into) the corresponding analog input port 110a by displaying “connected” if a sensor is plugged into the analog input port 110a or “absent” if no sensor is plugged into the analog input port 110a. In an embodiment, when the processor 118 detects that a sensor is plugged into the analog input port 110a, the processor 118 may cause the corresponding connection indicator graphical element 504 to display an indication that a sensor is “connected.” Additionally or alternatively, a user may manually indicate that a sensor is plugged into an analog input port 110a by toggling a toggle button graphical element 504 from “absent” to “connected.” Other words may be used to indicate the presence or absence of a sensor.

The sensor measurement unit graphical element 506 may comprise a pull-down menu that lists a plurality of units of measurement to allow the user to select a unit of measurement of the sensor plugged into the analog input port 110a. The units of measurement that may be displayed to the user in the pull-down menu may include amperes (Amp), Celsius (° C.), Fahrenheit (° F.), Hertz (Hz), microsiemens (μS), pascals (Pa). etc. The graphical user interface 500 may also allow the user to specify a measurement range of the sensor plugged into the analog input port 110a. For example, the sensor measurement unit graphical element 506 (e.g., the pull-down menu) may include different entries for different measurement ranges of the units of measurement of the sensors. As just an example, the pull-down menu may include multiple entries for the Amp unit of measurement, with different ones of the entries specifying different measurement ranges, such as 0-25 Amps, 0-50 Amps, etc. As just another example, the pull-down menu may include multiple entries for the ° F. unit of measurement, with different ones of the entries specifying different measurement ranges, such as 0-200° F., 0-500° F., etc.

The custom calibration value graphical element 508 may allow the user to specify a custom (e.g., non-standard) measurement range of a sensor by entering a calibration value for the sensor. The calibration value may be, for example, a value equal to 1000 divided by the maximum range of the sensor. In an example, the user may be advised (e.g., via a message displayed on the analog sensor setup graphical user interface 500) that the user may enter a calibration value if the measurement range of the sensor that the user is trying to set up is not present in the standard ranges listed in the drop down menu 504. The user may also be provided (e.g., via a message displayed by the sensor setup user interface 500) with a formula (e.g., 1000/maximum range of the sensor) for determining the calibration value to be entered into the calibration box 508 corresponding to the sensor.

In an embodiment, the processor 118 is configured to convert sensor signals acquired from the input ports 110a to sensor value based on the units of measurement and the standard or custom measurement ranges specified for the sensors by the user. For example, the processor 118 is configured to convert a value of a 4-20 mA signal acquired from an input port 110a to a current sensor value in the range of 0-50 Amps based on the indication provided by the user that the unit of measurement of the sensor is Amp and the measurement range of the sensor 0-50 Amps. As just another example, the processor 118 is configured to convert a value of a 4-20 mA signal acquired from an input port 110a to a temperature sensor value in the range of 0-500° F. based on the indication provided by the user that the unit of measurement of the sensor is ° F. and the measurement range of the sensor 0-500° F. In an embodiment, the processor 118 is configured to, if the user has provided a calibration value via a custom calibration value graphical element 508 corresponding to an input port 110a, perform the conversion of the values of the signal acquired from the input port 110a to sensor values based on the custom calibration value provided by the user. As just an example, the processor 118 may convert a value of a 4-20 mA signal acquired from the input port 110a to a current sensor value in the range of 0-6000 Amps based on the indication provided by the user that the unit of measurement of the sensor is Amp and the custom calibration value is ⅙ (i.e., 1000/6000).

The sensor value preview graphical element 510 may be configured to display a current sensor value converted by the processor 118 from a signal acquired from the corresponding input port 110a based on the unit of measurement and the standard or custom measurement range specified by the user. Displaying the current sensor value may, among other things, allow the user to confirm that the user has entered proper settings, such as correct unit of measurement and correct measurement range, for each sensor.

In an embodiment, the graphical user interface 500 may additionally include a main menu button or icon 520 that may allow the user to return to the main menu (e.g., the main menu graphical user interface 300 of FIG. 3) once the user has entered the sensor settings in the graphical user interface 500.

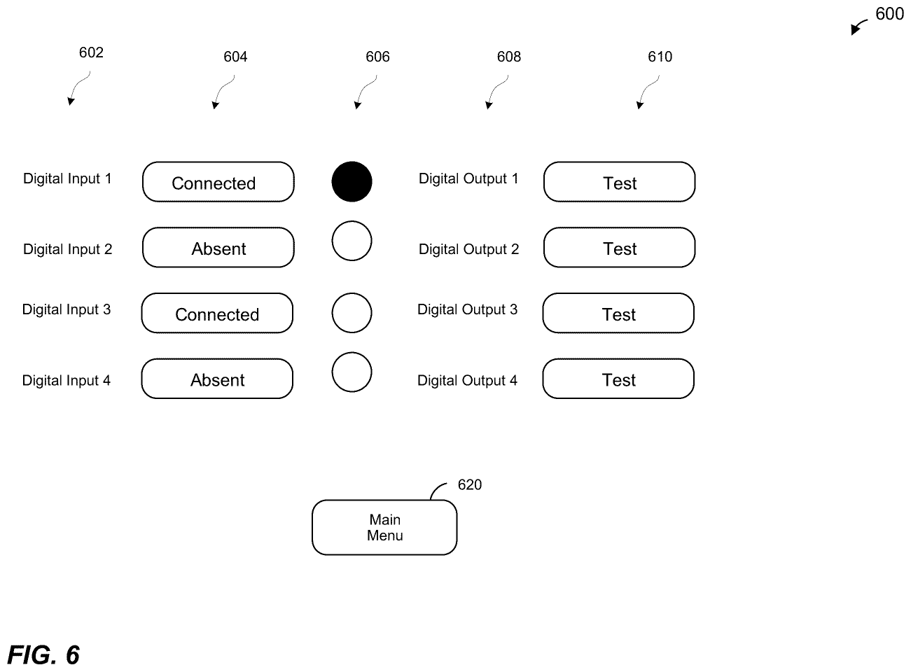

FIG. 6 is a diagram of a graphical user interface (sometimes referred to herein as “discrete I/O configuration graphical user interface”) 600 configured to provide a discrete I/O configuration menu to a user, according to an embodiment. The graphical user interface 600 may correspond to the graphical user interface 130 of the industrial controller device 100 of FIG. 1, and the graphical user interface 600 is described below in connection with the industrial controller device 100 of FIG. 1. In other embodiments, however, the graphical user interface 600 may be used with a suitable industrial controller device different from the industrial controller device 100 of FIG. 1 and/or in suitable industrial process systems different from the industrial system 102 of FIG. 1. Similarly, the industrial controller device 100 of FIG. 1 may be configured to display a discrete I/O configuration graphical user interface different from the graphical user interface 600, in some embodiments.

The discrete I/O configuration graphical user interface 600 may include a plurality of groups (e.g., rows) 602 of graphical elements that allow the user to provide sensor information for a plurality of digital sensors coupled with respective digital input ports 110b of the industrial controller device 100. Thus, for example, in an embodiment in which the industrial controller device 100 includes four digital input ports 110b, the discrete I/O configuration graphical user interface 600 includes four rows 602 of graphical elements respectively corresponding to respective ones of the four digital input ports 110b. Each of the rows 602 of graphical elements corresponds to a particular digital port 110b and includes a connection indicator graphical element 604 corresponding to the particular digital port 110b and a current status graphical element 606 corresponding to the digital input port 110b.

The connection indicator graphical element 604 may comprise a toggle button configured to indicate whether a sensor is coupled with (e.g., plugged into) the corresponding digital input port 110b by displaying “connected” if a sensor is plugged into the digital input port 110b or “absent” if no sensor is plugged into the digital input port 110b. In an embodiment, when the processor 118 detects that a sensor is plugged into the digital input port 110b, the processor 118 may cause the corresponding connection indicator graphical element 604 to display an indication that a sensor is “connected.” Additionally or alternatively, a user may manually indicate that a sensor is plugged into a digital input port 110b by toggling the corresponding toggle button 604 from “absent” to “connected.” Other words may be used to indicate whether a sensor is coupled with a corresponding digital input port 110b.

The current status graphical element 606 may display the current status of the sensor coupled with the corresponding digital input port 110b. For example, the status graphical element 606 may comprise a circle or other shape that is filled in (e.g., grey) if the current status of the sensor is “On” and not filled in (e.g., white) if the current status of the sensor is “Off”. The status graphical element 606 may be dynamically updated as the status of the sensor coupled with the digital input port 110b changes, in an embodiment. Other colors or indicators may be used to indicate the current status of the sensor coupled with the corresponding digital input port 110b.

The discrete I/O configuration graphical user interface 600 may also include a plurality of graphical elements 608 that allow the user to test digital outputs that may be provided by the industrial controller device 100 via the digital output ports 112. Thus, for example, in an embodiment in which the industrial controller device 100 includes four digital output ports 112, the discrete I/O configuration graphical user interface 600 includes four graphical elements 608 respectively corresponding to respective ones of the four digital output ports 112. Each of the graphical elements 608 corresponds to a particular digital output port 112 and includes a test button configured to toggle a control signal provided to the particular digital output port 112. The user may thus toggle the test button 608 to ensure that an industrial output device 104 coupled with the digital output port 114, e.g., via a relay 132. For example, by toggling a test button 608, the user may confirm that the industrial output device 104 coupled with the corresponding digital output port 114 via a relay 132 is properly turned On and turned OFF via toggling of the relay 132. In an embodiment, the graphical user interface 600 may additionally include a main menu button or icon 620 that may allow the user to return to the main menu (e.g., the main menu graphical user interface 300 of FIG. 3).

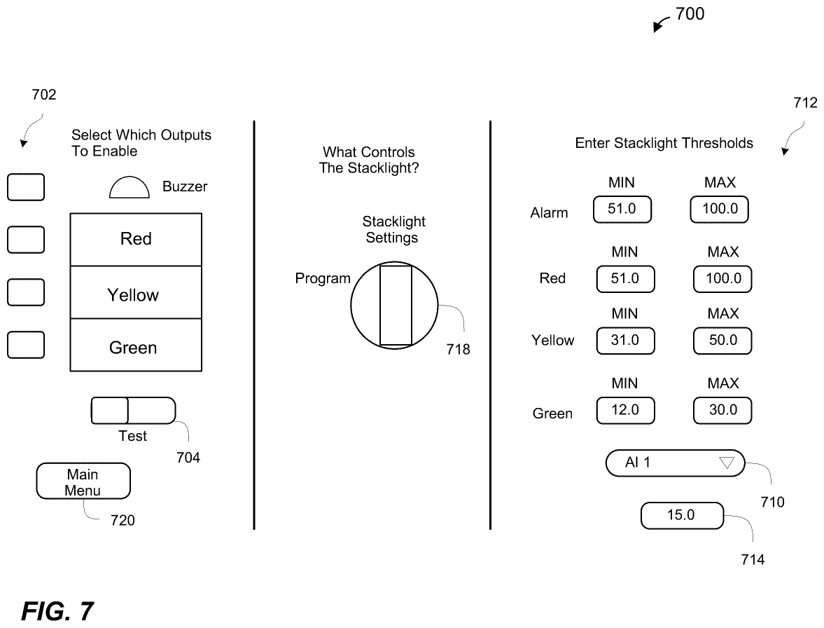

FIG. 7 is a diagram of a graphical user interface (sometimes referred to herein as “stacklight setup menu graphical user interface”) 700 configured to provide a stacklight setup menu to a user, according to an embodiment. The graphical user interface 700 may correspond to the graphical user interface 130 of the industrial controller device 100 of FIG. 1, and the graphical user interface 700 is described below in connection with the industrial controller device 100 of FIG. 1. In other embodiments, however, the graphical user interface 700 may be used with a suitable industrial controller device different from the industrial controller device 100 of FIG. 1 and/or in suitable industrial process systems different from the industrial system 102 of FIG. 1. Similarly, the industrial controller device 100 of FIG. 1 may be configured to display a stacklight setup menu graphical user interface different from the graphical user interface 700, in some embodiments.

The stacklight setup menu graphical user interface 700 includes selectable graphical elements 702 that allow the user to indicate which colors are supported by a stacklight coupled with the industrial controller device 100 (e.g., plugged into the indicator output port 114 of the industrial controller device 100) and/or whether an alarm (e.g., a buzzer) is coupled with the industrial controller device 100 (e.g., provided with the stacklight plugged into the indicator output port 114 of the industrial controller device 100). The stacklight setup menu graphical user interface 700 may further include a test switch or other graphical element 704 that may allow the user to test the stacklight and/or the alarm to ensure that the stacklight and/or the alarm can be properly controlled by the industrial controller device 100.

The stacklight setup menu graphical user interface 700 may also include fields or other graphical elements that allow the user to enter thresholds for controlling the lights and/or the buzzer coupled with the industrial controller device 100 based on sensor signals acquired via analog input ports 110a. For example, the stacklight setup menu graphical user interface 700 may include a dropdown menu or other graphical element 710 configured to allow the user to select a particular analog input ports 110a to be used for controlling the stacklight and/or the alarm. The stacklight setup menu graphical user interface 700 may also include fields 712 that allow the user to enter minimum and maximum thresholds for each color of the stacklight and for the alarm. The stacklight setup menu graphical user interface 700 may also include a box or other graphical element 714 configured to display the current sensor value of the analog sensor coupled with the particular analog input port 110a.

The processor 118 of the industrial controller device 100 may be configured to control the stacklight and/or the alarm based on the sensor signals acquired via the particular analog input port 110 selected by the user via the menu 710 according to the thresholds entered by the user via the fields 712, in an embodiment. Thus, for example, the processor 118 may control the stacklight 114 i) to light green when the current sensor value obtained based on sensor signal acquired from the particular analog input port 110 is between minimum and maximum thresholds (e.g., between 12.0 and 30.0 in FIG. 7) indicated by the user for the green light in the fields 712, ii) to light yellow when the current sensor value obtained based on sensor signal acquired from the particular analog input port 110 is between minimum and maximum thresholds (e.g., between 31.0 and 50.0 in FIG. 7) indicated by the user for the yellow light in the fields 712, and iii) to light red when the current sensor value obtained based on sensor signal acquired from the particular analog input port 110 is between minimum and maximum thresholds (e.g., between 51.0 and 100.0 in FIG. 7) indicated by the user for the red light in the fields 712. Additionally, the processor 118 may control the alarm to be provided (e.g., via sounding the buzzer) when the current sensor value obtained based on sensor signal acquired from the particular analog input port 110 is between minimum and maximum thresholds (e.g., between 51.0 and 100.0 in FIG. 7) indicated by the user for the alarm in the fields 712.

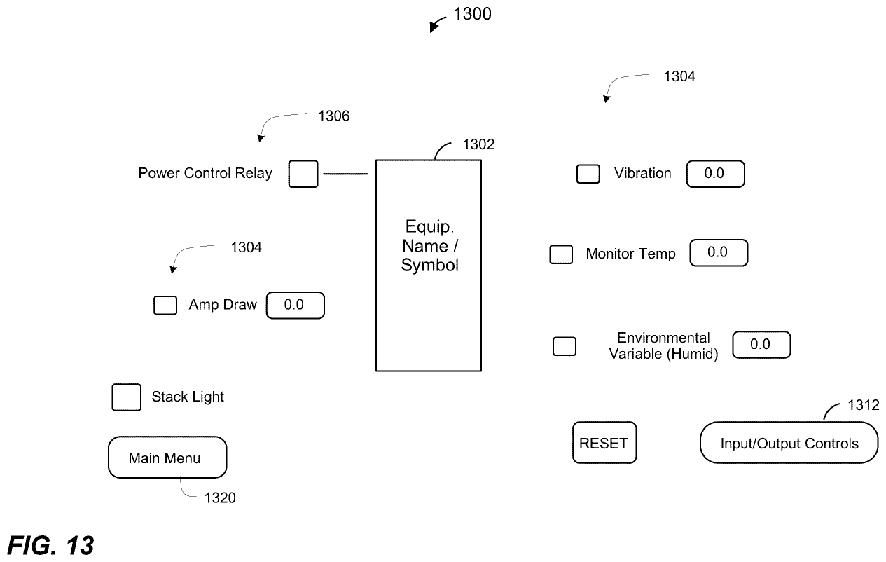

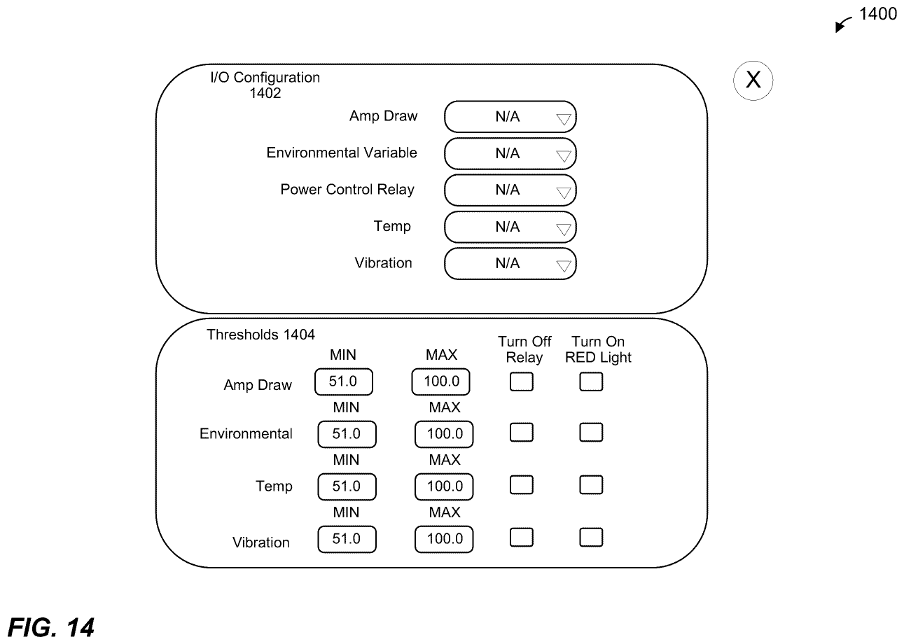

In an embodiment, the stacklight setup menu graphical user interface 700 may also include a switch or other graphical element 718 that allow the user to select or otherwise specify whether stacklight 144 is to be controlled i) using a setup separately provided by the user via another application (e.g., via a specific equipment application described in more detail below with reference to FIGS. 13 and 14) or ii) using the setup provided in the stacklight setup menu graphical user interface 700. The user may use the switch 718 to switch control of stacklight i) to a program mode to indicate that thresholds set in another application are to be used for controlling the stacklight 144 or ii) to a stacklight setup mode to indicate that the thresholds set via the stacklight setup menu graphical user interface 700 are to be used. The processor 118 may be configured to control the stacklight 144 according to the setting of the switch 718. In an embodiment, the processor 118 is configured to, if the switch 718 is set to the stacklight setup mode, override thresholds set in any other application with the thresholds provided by the user via the stacklight setup menu graphical user interface 700.

In an embodiment, the graphical user interface 700 may additionally include a main menu button or icon 720 that may allow the user to return to the main menu (e.g., the main menu graphical user interface 300 of FIG. 3).

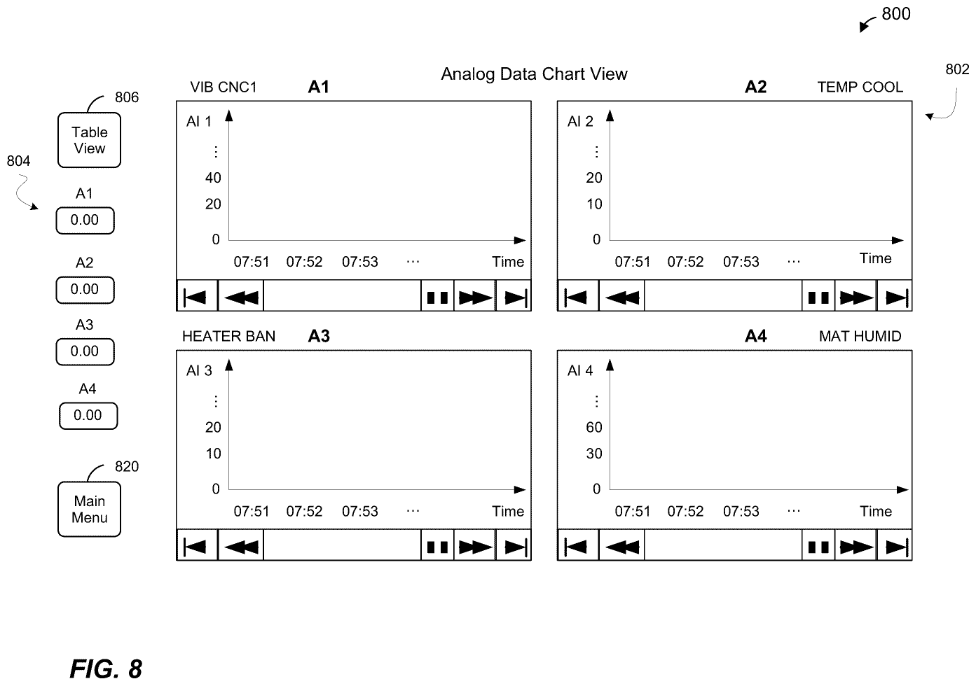

FIGS. 8-10 are diagrams of example graphical user interfaces (sometimes referred to herein as “data view graphical user interface”) 800, 900, 1000 configured to display various views of sensor measurement data generated based on sensor signals acquired from analog sensor input ports 110a to a user, according to an embodiment. The graphical user interfaces 800, 900, 1000 may correspond to the graphical user interface 130 displayed on the display device of the industrial controller device 100 of FIG. 1, and the graphical user interfaces 800, 900, 1000 are described below in connection with the industrial controller device 100 of FIG. 1. In other embodiments, however, the graphical user interfaces 800, 900, 1000 may be used with a suitable industrial controller device different from the industrial controller device 100 of FIG. 1 and/or in suitable industrial process systems different from the industrial system 102 of FIG. 1. Similarly, the industrial controller device 100 of FIG. 1 may be configured to display data view graphical user interfaces different from the graphical user interfaces 800, 900, 1000, in some embodiments.

The data view graphical user interface 800 of FIG. 8 is configured to display the historical sensor values in analog data chart form, according to an embodiment. The data view graphical user interface 800 includes respective data charts 802 corresponding to the analog input ports 110a. The data charts 802 are configured to display plots of sensor values obtained based on signals acquired from the analog input ports 110a as a function of time. The data view graphical user interface 800 may also include respective boxes or other graphical elements 804 configured to dynamically display current sensor values obtained based on the signals acquired from the analog input ports 110a. In an embodiment, the graphical user interface 800 may additionally include a main menu button or icon 820 that may allow the user to return to the main menu (e.g., the main menu graphical user interface 300 of FIG. 3).

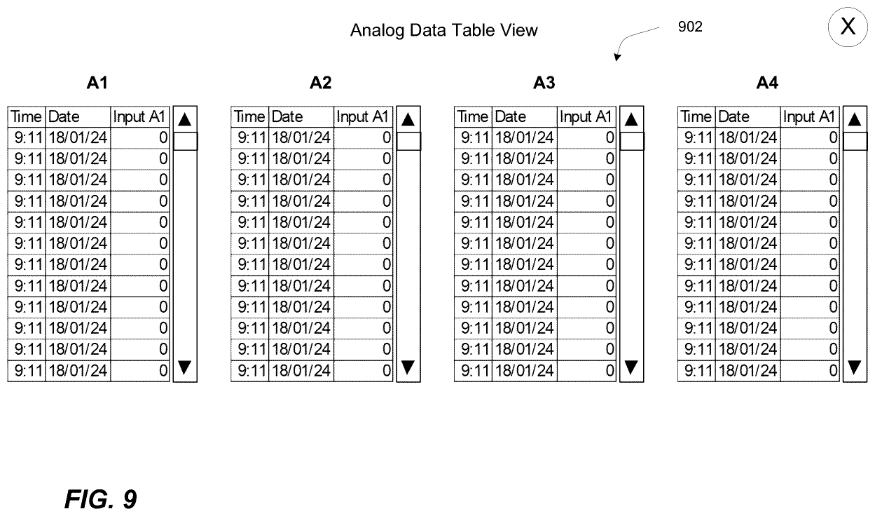

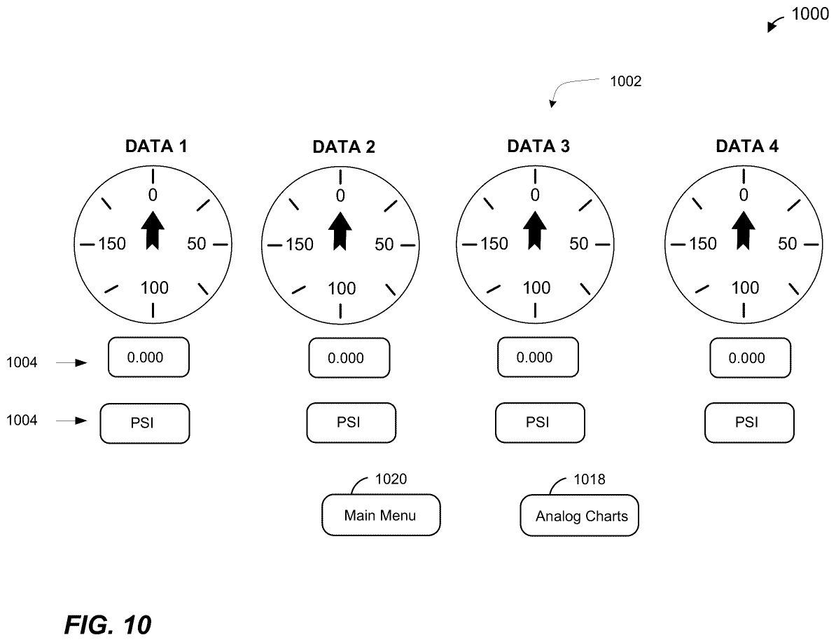

The data view graphical user interface 900 of FIG. 9 is configured to display the historical sensor values in data table form, according to an embodiment. The data view graphical user interface 900 may be displayed to the user when the user touches or otherwise engages with a table view button 806 that may be displayed to the user in the graphical user interface 800 of FIG. 8, for example. The data view graphical user interface 900 includes respective data tables 902 corresponding to the analog input ports 110a. The data tables 902 are configured to display tables of sensor values obtained based on signals acquired from the analog input ports 110a mapped over time. The data view graphical user interface 1000 of FIG. 10 is configured to display a summary of the sensor measurement values. The data view graphical user interface 1000 includes respective sensor graphics 1002 (e.g., pressure gauge graphics in the example of FIG. 10) corresponding to sensors coupled with respective analog input ports 110a. The sensor graphics 1002 may dynamically display the current sensor values of the sensors coupled with respective analog input ports 110a in graphical form. The data view graphical user interface 1000 may also include graphical elements 1004 corresponding to sensors coupled with respective analog input ports 110a and configured to dynamically display the current sensor values of the sensors coupled with respective analog input ports 110a and corresponding graphical elements 1006 configured to display the units of measurement of the corresponding sensors. The graphical user interface 1000 may also include an analog charts button or icon 1018 that may allow the user to pull up (or return to) a data chart view (e.g., the data view graphical user interface 800 of FIG. 8). In an embodiment, the graphical user interface 1000 may additionally include a main menu button or icon 1020 that may allow the user to return to the main menu (e.g., the main menu graphical user interface 300 of FIG. 3).

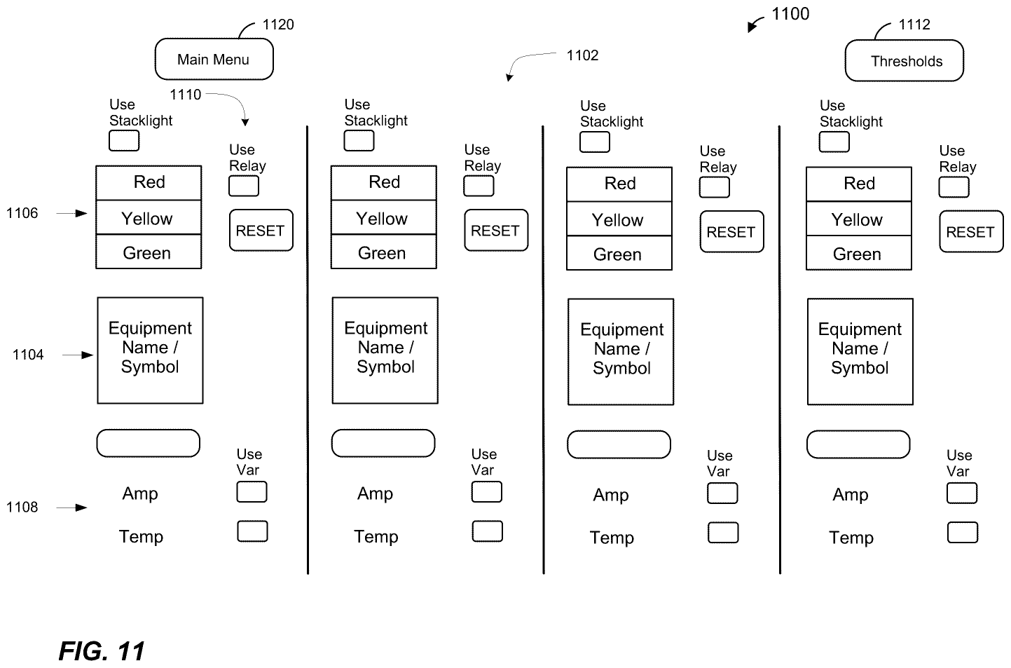

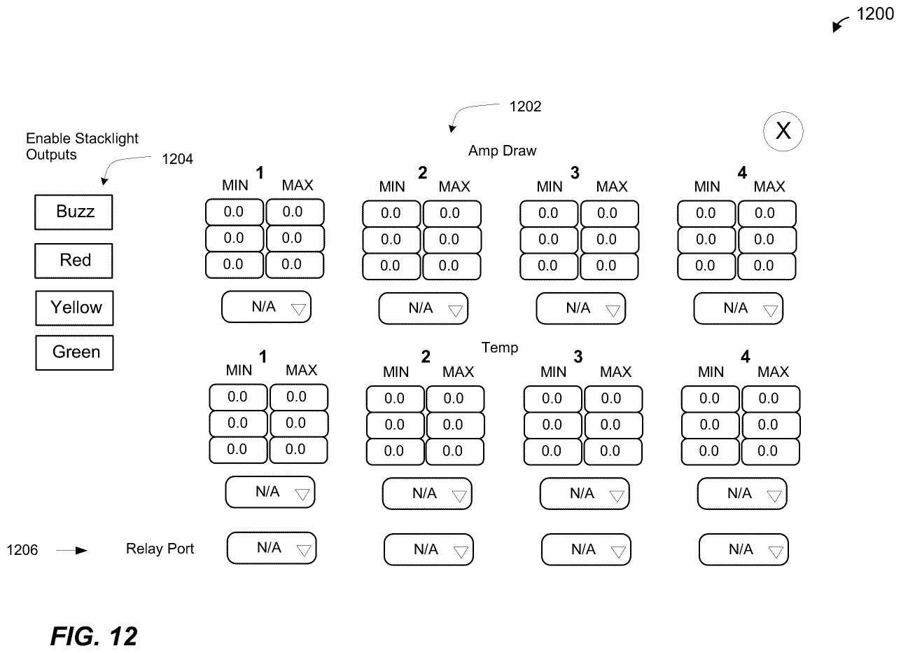

FIGS. 11 and 12 are diagrams of example graphical user interfaces (sometimes referred to herein as “industrial output device monitoring and control graphical user interface”) 1100, 1200 configured to enable a user to provide configuration information for monitoring and/or control of different industrial output devices, according to an embodiment. The graphical user interfaces 1100, 1200 may correspond to the graphical user interface 130 of the industrial controller device 100 of FIG. 1, and the graphical user interfaces 1100, 1200 are described below in connection with the industrial controller device 100 of FIG. 1. In other embodiments, however, the graphical user interfaces 1100, 1200 may be used with a suitable industrial controller device different from the industrial controller device 100 of FIG. 1 and/or in suitable industrial process systems different from the industrial system 102 of FIG. 1. Similarly, the industrial controller device 100 of FIG. 1 may be configured to display industrial output device monitoring and control graphical user interfaces different from the graphical user interfaces 1100, 1200, in some embodiments.

The graphical user interface 1100 of FIG. 11 includes respective panels 1102 configured to allow the user to provide configuration information for monitoring and/or control of respective industrial output devices. Each of the panels 1102 may include a graphic 1104 visually illustrating a type of the corresponding industrial output device. Each of the panels 1102 may also include graphical elements 1106 configured to display states (e.g., green, yellow, red) of a measured parameter of the corresponding industrial output device. Each of the panels 1102 may also include graphical elements 1108 configured to allow the user to select whether the measured parameter is current draw (Amp) or temperature (Temp). In other examples, the graphical elements 1108 may additionally or alternatively allow the user to select from among types of parameters other than current draw and temperature. Each of the panels 1102 may also include graphical elements 1108, a relay checkbox or other graphical element 1110 configured to allow the user to indicate whether a relay is to be triggered, for example when the value of the measured parameter exceeds a threshold specified by the user. In an embodiment, the graphical user interface 1100 may additionally include a main menu button or icon 1120 that may allow the user to return to the main menu (e.g., the main menu graphical user interface 300 of FIG. 3).

The graphical user interface 1200 of FIG. 12 is configured to allow the user to enter thresholds for monitoring and/or controlling the industrial output devices graphically shown in the graphical user interface 1100 of FIG. 11. The graphical user interface 1200 may be displayed to the user when the user touches or otherwise engages with a thresholds button 1112 that may be displayed to the user in the graphical user interface 1100 of FIG. 11. The graphical user interface 1200 may include graphical elements 1202 for entering minimum and maximum threshold values for each of three states (e.g., green, yellow, and red) for current draw and/or temperature parameters of each of the industrial output devices. In other examples, the graphical elements 1202 may additionally or alternatively allow the user to enter minimum and maximum threshold values for parameters other than current draw and temperature. The graphical user interface 1200 may additionally include graphical elements 1204 configured to allow the user to select which lights are supported by a stacklight coupled with the indicator output port 114. The graphical user interface 1200 may additionally include graphical elements 1206 configured to allow the user to select which digital output port is to be used for controlling the corresponding industrial output device via a relay if such control is specified for the industrial controller device in the graphical user interface 1100 of FIG. 11.

Referring still to FIGS. 11 and 12, the processor 118 is configured to display the states of the parameters via the graphical elements 1106 of the graphical user interface 1100 according to the thresholds provided by the user via the graphical user interface 1200. In an embodiment, the processor 118 is also configured to control the stacklight coupled with the indicator output port 114 based on the thresholds provided by the user via the graphical user interface 1200. For example, the processor 118 is configured to generate and provide to a control signal to the indicator output port 114 to cause the stacklight to show the light corresponding to the most elevated state of the industrial output devices according to the thresholds provided by the user via the graphical user interface 1200. Thus, for example, if all of the monitored parameters of the industrial output devices are in green state, then the processor 118 may cause the stacklight to show a green light. Further, if at last one of the monitored parameters of the industrial output devices is in yellow state while the remaining monitored parameters of the industrial output devices are in green state, then the processor 118 may cause the stacklight to show a yellow light. Further still, if at last one of the monitored parameters of the industrial output devices is in red state, then the processor 118 may cause the stacklight to show a red light. The user may then refer to the graphical elements 1106 of the graphical user interface 1100 to see which one(s) of the industrial devices caused the stacklight to show the yellow or the red light, in an embodiment.

FIGS. 13 and 14 are diagrams of example graphical user interfaces (sometimes referred to herein as “industrial output device monitoring and control graphical user interface”) 1300, 1400 configured to enable a user to provide configuration information for monitoring and/or control of a particular industrial output device, according to an embodiment. The graphical user interfaces 1300, 1400 may correspond to the graphical user interface 130 of the industrial controller device 100 of FIG. 1, and the graphical user interfaces 1300, 1400 are described below in connection with the industrial controller device 100 of FIG. 1. In other embodiments, however, the graphical user interfaces 1300, 1400 may be used with a suitable industrial controller device different from the industrial controller device 100 of FIG. 1 and/or in suitable industrial process systems different from the industrial system 102 of FIG. 1. Similarly, the industrial controller device 100 of FIG. 1 may be configured to display industrial output device monitoring and control graphical user interfaces different from the graphical user interfaces 1300, 1400, in some embodiments.

The graphical user interface 1300 may include a graphic 1302 illustrating the particular industrial output device (e.g., a drill press). The graphical user interface 1300 may also include a plurality of selectable graphical elements 1304 representing various parameters (e.g., current draw, vibration, temperature, humidity, etc.) that allow the user to select which parameters of the industrial output device the user wishes to monitor using sensors coupled with input ports 110a, 110b, and corresponding graphical elements (e.g., boxes) configured to dynamically display current values of the corresponding parameters. The graphical user interface 1300 may additionally include a power control relay graphical element 1306 configured to allow the user to indicate whether control of the industrial output device is to be performed via a relay coupled with a digital output port 112. In an embodiment, the graphical user interface 1300 may additionally include a main menu button or icon 1320 that may allow the user to return to the main menu (e.g., the main menu graphical user interface 300 of FIG. 3).

The graphical user interface 1400 of FIG. 14 is configured to allow the user to enter or provide configuration information for monitoring and/or controlling the industrial output device graphically shown in the graphical user interface 1300 of FIG. 13. The graphical user interface 1400 may be displayed to the user when the user touches or otherwise engages with an input/output controls button 1312 that may be displayed to the user in the graphical user interface 1300 of FIG. 13. The graphical user interface 1400 may include graphical elements 1402 for indicating which ports among the input ports 110a, 110b are to be used for acquiring sensor signals from sensors measuring the parameters selected by the user in the graphical user interface 1300 of FIG. 13 and, if desired, which output port 112 is to be used for controlling the industrial output device. The graphical user interface 1400 may also include graphical elements 1404 for providing thresholds to be used for monitoring the parameters selected by the user in the graphical user interface 1300 of FIG. 13, and whether a red light is to be shown via a stacklight coupled with indicator output port 114 and/or whether the relay is to be triggered when the value of the parameter exceeds the maximum threshold.

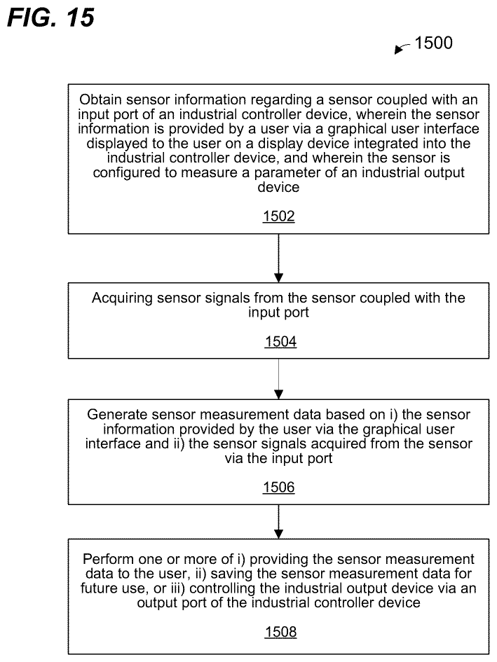

FIG. 15 is a flow diagram of an example method 1500 for operating an industrial controller device, according to an embodiment. In one embodiment, the method 1500 is implemented in the processor 118 of the controller device 100 of FIG. 1, and the method 1500 is described with reference to FIG. 1 merely for explanatory purposes. In other embodiments, the method 1500 is implemented in another suitable industrial controller device.

At a block 1502, the processor 118 may obtain sensor information regarding a sensor coupled with an input port 110a, 110b of the industrial controller device 100. The sensor information may be provided by a user via the graphical user interface 130 displayed to the user on the display device 116 that may be integrated with the industrial controller device 100. The sensor may be configured to measure a parameter of an industrial output device. For example, the sensor may be an analog sensor (e.g., a sensor 124a) plugged into an analog port 110a of the industrial controller device 100. As another example, the sensor may be a digital sensor plugged into a digital port 110b of the industrial controller device 100.

At a block 1504, the processor 118 may acquire sensor signals from the sensor coupled with the input port 110a, 110b. The sensor signals may be 4-20 mA signals, for example.

At a block 1506, the processor 118 may generate sensor measurement data based on i) the sensor information provided by the user via the graphical user interface and ii) the sensor signals acquired from the sensor via the input port. For example, the sensor information may include a unit of measurement of the sensor and a measurement range of the sensor, and the processor 118 may generate the sensor measurement data by converting the sensor signals to sensor measurement values based on the range of the sensor provided by the user via the graphical user interface, and to associate the sensor measurement data with the unit of measurement of the sensor provided by the user via the graphical user interface.

At a block 1508, the processor 118 may perform at least one action with respect to the sensor measurement data. For example, the processor 118 may perform one or more of i) providing the sensor measurement data to the user, ii) saving the sensor measurement data for future use, or iii) controlling the industrial output device via an output port of the industrial controller device.

The embodiments disclosed herein provide an industrial controller device that is equipped with input ports, output ports, a processor, and a display device, and that allows easy and intuitive configuration of monitoring and/or control, to be performed by the controller device, by a user via intuitive graphical interfaces displayed to the user on the display device. The user may thus easily configure the industrial controller device to perform monitoring and/or control of an industrial output device using various prompts and graphical elements (e.g., pull-down menus, text boxes, checkboxes, etc.) displayed to the user on the display device. The industrial controller device may be used to monitor and/or control industrial output devices in industrial systems in which use of traditional controller that need to be programmed using a programming language, such as Python, C, Ladder Logic, etc., may not be feasible, such as at small manufacturing shops or plants that may lack personnel with specialized programming skills, for example. Use of the disclosed industrial controller devices in such environments may allow operators of the small manufacturing shops or plants to increase efficiency of industrial output devices used at the manufacturing shops or plants, prolong life of the industrial output devices, reduce or eliminate downtime and cost associated with repairing the industrial output devices, etc. In other examples, the disclosed industrial controller devices may be used in other environments, such as in larger manufacturing shops or plants.

At least some of the various blocks, operations, and techniques described above may be implemented utilizing hardware, a processor executing firmware instructions, a processor executing software instructions, or any combination thereof. When implemented utilizing a processor executing software or firmware instructions, the software or firmware instructions may be stored in any computer readable memory such as on a magnetic disk, an optical disk, or other storage medium, in a RAM or ROM or flash memory, processor, hard disk drive, optical disk drive, tape drive, etc. The software or firmware instructions may include machine readable instructions that, when executed by one or more processors, cause the one or more processors to perform various acts.

When implemented in hardware, the hardware may comprise one or more of discrete components, an integrated circuit, an application-specific integrated circuit (ASIC), a programmable logic device (PLD), etc.

When a component, device, element, or the like of the present disclosure is described as having a purpose or performing an operation, function, or the like, the component, device, or element should be considered herein as being “configured to” meet that purpose or to perform that operation or function.

While the present disclosure has been described with reference to specific examples, which are intended to be illustrative only and not to be limiting of the disclosure, changes, additions and/or deletions may be made to the disclosed embodiments without departing from the scope of the disclosure.

What is claimed is:

1. An industrial controller device, comprising:
one or more input ports configured to couple with one or more sensors;
one or more output ports configured to couple with one or more industrial output devices;
a display device configured to display a graphical user interface to a user; and
a processor coupled to the one or more input ports, the one or more output ports, and the display device, the processor configured to:
obtain sensor information regarding a sensor coupled with an input port among the one or more input ports, wherein the sensor information is provided by the user via the graphical user interface, and wherein the sensor is configured to measure a parameter of an industrial output device;
acquire sensor signals from the sensor via the input port;
generate sensor measurement data based on i) the sensor information provided by the user via the graphical user interface and ii) the sensor signals acquired from the sensor via the input port; and
perform one or more of i) providing the sensor measurement data to the user, ii) saving the sensor measurement data for future use, or iii) controlling the industrial output device via an output port among the one or more output ports of the industrial controller device.

2. The industrial controller device of claim 1, wherein the processor is configured to:
detect that the sensor is plugged into the input port among the one or more input ports; and
in response to detecting that the sensor is plugged into the input port, display, on the graphical user interface, graphical elements requesting the sensor information from the user.

3. The industrial controller device of claim 1, wherein the one or more input ports include one or both of:
one or more analog input ports configured to couple with one or more analog sensors; or
one or more digital input ports configured to couple with one or more digital sensors.

4. The industrial controller device of claim 1, wherein, for an analog sensor coupled to an analog port among the one or more analog ports, the sensor information includes a selection of a unit of measurement and a measurement range of the analog sensor.

5. The industrial controller device of claim 4, wherein the unit of measurement is selected, by the user, from a set of units of measurements displayed to the user via a menu on the graphical user interface, the set of units of measurements including one or more of millimeters per second (MMS), amperes, volts, degrees, inches, pounds per square inch (PSI), microsiemens, or Hertz (Hz).

6. The industrial controller device of claim 4, wherein the processor is configured to generate the sensor measurement data by converting the sensor signals acquired from the analog sensor via the input port to measurement values of a parameter associated with operation of an industrial output device.

7. The industrial controller device of claim 6, wherein the parameter comprises one of i) a current draw of the industrial output device, ii) an operating temperature of the industrial output device, iii) a pressure experienced by at least a portion of the industrial output device, or iv) a vibration experienced by at least a portion of the industrial output device.

8. The industrial controller device of claim 6, wherein the processor is configured to:
generate, based on the sensor signals acquired from the analog sensor via the input port, historical data including a plurality of measurement values of the parameter over time;
store the historical data in a memory;
receive, via the graphical user interface from the user, a request to view the historical data; and
in response to receiving the request to view the historical data, cause the historical data to be displayed in the graphical user interface to the user.

9. The industrial controller device of claim 6, wherein the processor is configured to:
obtain, from the user via the graphical user interface, one or more monitoring conditions including one or more of a normal state condition, a warning state condition, or an alarm state condition;
monitor the parameter based on the sensor signals acquired from the sensor to determine a state of the parameter according to the one or more monitoring conditions; and
cause an indication of the state of the parameter to be provided to the user.

10. The industrial controller device of claim 9, wherein the processor is configured to cause the indication of the state of the parameter to be provided to the user by one or more of i) generating and providing a control signal to an output indicator port of the industrial controller device to cause the indication of the state of the parameter to be provided to the user via a stacklight coupled with the indicator output port, ii) displaying the indication of the state of the parameter in the graphical user interface, or iii) causing the indication of the state of the parameter to be transmitted over a communication network to a user device of the user.

11. The industrial controller device of claim 4, wherein the processor is configured to, based on sensor signals acquired from a digital sensor coupled to a digital port among the one or more digital ports, perform one of i) determine when a part is made by the industrial output device, ii) count a number of parts produced by the industrial output device, or iii) calculate overall equipment efficiency (OEE) of the industrial output device.

12. The industrial controller device of claim 1, wherein:
the industrial output device is coupled with the output port via a relay; and
the processor is configured to control the industrial output device by triggering the relay to turn on at least a portion of the industrial output device or turn off at least the portion of the industrial output device.

13. The industrial controller device of claim 1, further comprising a housing, wherein the one or more input ports, the one or more output ports, the display device, and the processor are integrated together within the housing.

14. The industrial controller device of claim 13, further comprising a network switch housed within the housing, wherein the network switch is coupled to the display device and the processor and is configured to route signals between the display device and the processor.

15. The industrial controller device of claim 13, further comprising one or both of an Ethernet communication interface or a wireless communication interface coupled to the processor.

16. The industrial controller device of claim 15, wherein the processor is further configured to:
receive sensor setup information for acquiring data from a sensor via one of the Ethernet communication interface or the wireless communication interface, the sensor setup information provided by the user via the graphical user interface; and
acquire sensor signals from the sensor based on the sensor setup information provided by the user via the graphical user interface.

17. An industrial controller device, comprising:
a housing;
one or more input ports packaged within the housing, the one or more input ports configured to couple with one or more sensors coupled with one or more industrial output devices;
a display device packaged within the housing, the display device configured to display a graphical user interface to a user; and
a processor packaged within the housing and coupled to the one or more input ports and the display device, the processor configured to:
obtain sensor information regarding a sensor coupled with an input port among the one or more input ports, wherein the sensor information is provided by the user via the graphical user interface, and wherein the sensor is configured to measure a parameter of an industrial output device of the one or more industrial output devices;
acquire sensor signals from the sensor via the input port;
generate sensor measurement data based on i) the sensor information provided by the user via the graphical user interface and ii) the sensor signals acquired from the sensor via the input port; and
provide the sensor measurement data to the user.

18. The industrial controller device of claim 17, further comprising an output port packaged within the housing and coupled with the industrial output device, wherein the processor is further configured to:
obtain, from the user via the graphical user interface, a condition for controlling the industrial output device based on the parameter; and
control the industrial output device based on the sensor measurement data according to the condition provided by the user via the graphical user interface.

19. A method for operating an industrial controller device, the method comprising:
obtaining, by a processor of the industrial controller device, sensor information regarding a sensor coupled with an input port of the industrial controller device, wherein the sensor information is provided by a user via a graphical user interface displayed to the user on a display device integrated into the industrial controller device, and wherein the sensor is configured to measure a parameter of an industrial output device;
acquiring, by the processor via the input port, sensor signals from the sensor coupled with the input port;
generating, by the processor, sensor measurement data based on i) the sensor information provided by the user via the graphical user interface and ii) the sensor signals acquired from the sensor via the input port; and
performing, by the processor, one or more of i) providing the sensor measurement data to the user, ii) saving the sensor measurement data for future use, or iii) controlling the industrial output device via an output port of the industrial controller device.

20. The method of claim 19, further comprising:
detecting, by the processor, that the sensor is plugged into the input port among the one or more input ports; and
in response to detecting that the sensor is plugged into the input port, displaying, by the processor on the graphical user interface, graphical elements requesting the sensor information from the user.
